(19) United States
(12) Patent Application Publication
(10) Pub. No.: US 2008/0055024 A1
(43) Pub. Date: Mar. 6, 2008

(54) SYSTEM AND METHOD FOR PROTECTION OF UNPLANNED STATE CHANGES OF A MAGNETIC LATCHING RELAY

(75) Inventor: Stephen L. Kersten, Coral Springs, FL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Plantation, FL (US)

(21) Appl. No.: 11/469,334

(22) Filed: Aug. 31, 2006

(51) Int. Cl. H01H 51/22

(52) U.S. Cl. 335/79

(57) ABSTRACT

A system for protecting against unplanned state changes of a magnetic latching relay (100) includes logic switching logic circuits (101, 105) for controlling a driver circuit (103) that works to supply a drive voltage to a magnetic latching relay (109). The switching logic circuits (101, 105) work to detect any unplanned state changes that may occur due to vibration or the like of the magnetic latching relay (109). The invention acts to switch the magnetic latching relay (109) back to a desired state after this state change has been detected in a two-way radio transceiver or other electronic device.

### FIELD OF THE INVENTION

The present invention relates generally to magnetic latching relays and more particularly to state changes in magnetic latching relay circuits.

### BACKGROUND

Relays are typically electrically controlled two-state devices that open and close electrical contacts to effect operation of devices in an electrical circuit. Thus, relays typically function as switches that activate or de-activate portions of an electrical, optical or other device. Relays are commonly used in many applications including telecommunications, radio frequency (RF) communications, portable electronics, consumer and industrial electronics, aerospace, and other systems.

Although the earliest relays were mechanical or solid-state devices, recent developments in micro-electro-mechanical systems (MEMS) technologies and microelectronics manufacturing have made micro-electrostatic and micro-magnetic relays possible. Such micro-magnetic relays typically include an electromagnet that energizes an armature to make or break an electrical contact. When the magnet is de-energized, a spring or other mechanical force typically restores the armature to a quiescent position. Such relays typically exhibit a number of marked disadvantages, however, in that they generally exhibit only a single stable output (i.e., the quiescent state) and they are not latching (i.e., they do not retain a constant output as power is removed from the relay). Moreover, the spring required by conventional micro-magnetic relays may degrade or break over time. A micro-magnetic relay is described in U.S. Pat. No. 5,847,631 issued to Taylor et al. on Dec. 8, 1998, the entirety of which is incorporated herein by reference.

The most common relays utilize a permanent magnet and an electromagnet for generating a magnetic field that intermittently opposes the field generated by the permanent magnet. Although this relay purports to be bi-stable, the relay requires consumption of power in the electromagnet to maintain at least one of the output states. Moreover, the power required to generate the opposing field would be significant, thus making the relay unsuitable for use in space, portable electronics, and other applications that demand low power consumption.

Thus, the need exists for a bi-stable, latching relay that does not require power to hold the states. Such a relay should also be reliable, simple in design, low cost and easy to manufacture.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of a system for protection of unplanned state changes of a magnetic latching relay in accordance an embodiment of the invention.

FIG. 2 is a block diagram of the system of FIG. 1 using a tri-state control input.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a system for protection of unplanned state changes of a magnetic latching relay. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a system for protection of unplanned state changes of a magnetic latching relay described herein. The non-processor circuits may include, but are not limited to, a radio receiver, a radio transmitter, signal drivers, clock circuits, power source circuits, and user input devices. As such, these functions may be interpreted as steps of a method to perform a system for protection of unplanned state changes of a magnetic latching relay. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could also be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

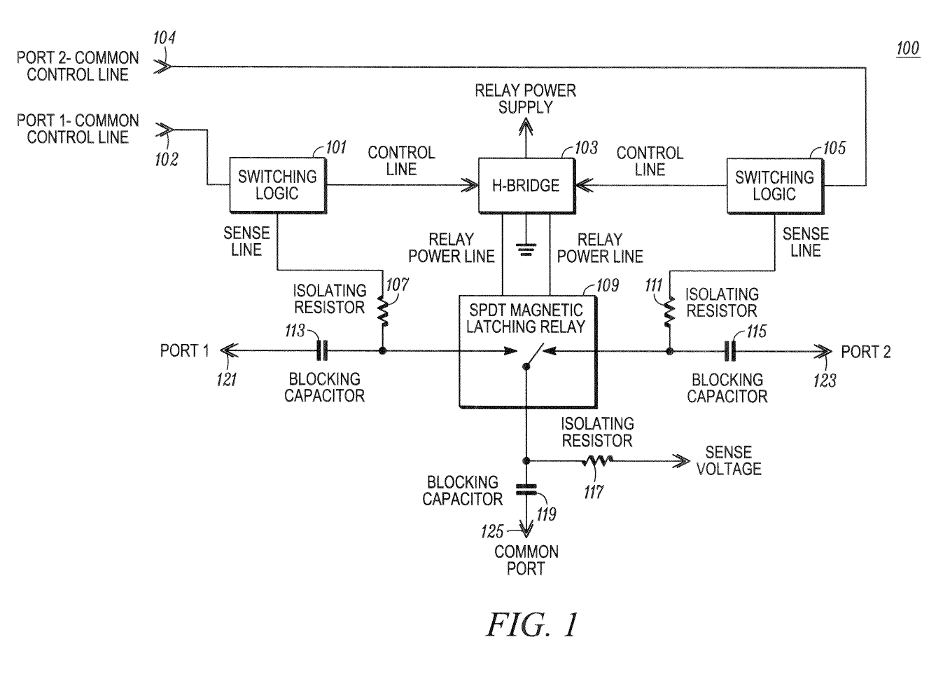

FIG. 1 illustrates a block diagram of a system for protection of unplanned state changes of a magnetic latching relay 100 according to an embodiment of the invention. A state controller (not shown) is used to provide a control signal to either the common control line 102 controlling port 121 or common control line 104 for controlling port 123. The control signal is applied as long as a particular relay state is desired. In this circuit, the controlling signal is a HIGH level, but can be modified to operate for a positive or negative polarity. A HIGH control signal is typically divided in half, which is then applied to the switching logic 101, 105. Those skilled in the art will recognize that the switching logic is typically an operational amplifier or the like. This, in turn, causes the output of the switching logic 101, 105 to swing to a HIGH state for controlling an H-bridge 103. Those skilled in the art will recognize that the H-bridge 103 may be a pair of metal oxide semiconductor field effect transistor (MOSFET) drivers or similar switching device. The H-bridge 103 switches a power supply voltage to a relay actuating coil (not shown) of the single pole double throw (SPDT) magnetic latching relay 109. This process causes the relay 109 to switch its present state to either port 121 or port 123. The magnetic switching relay 109 may be used in a two-way radio transceiver or the like. As seen in FIG. 1, the relay 109 includes ports 121, 123 and 125 where port 125 is a common port switched to either of ports 121, 123. Each port includes a respective blocking capacitor 113, 115, 119 which is used to block any direct current (DC) voltages present at the port.

In operation, a control voltage (typically 5 volts) is placed on a common port on the SPDT relay 109. This control voltage is typically applied to the switched side of the relay 109. Typically, this switched control voltage is at an amplitude that is higher than the divided input control signal 102, 104. Similarly, when this voltage is then applied to the negative input of the switching logic 101, 105, this will cause the output of the switching logic 101, 105 to swing to a LOW state, thus stopping any current flow through the H-bridge 103. In this situation, the H-bridge 103 has reached its quiescent state and only draws minimal current. Hence the H-bridge 103 operates simply using two logic level inputs and two outputs. If the common control line 102, operating the port 121 is HIGH, then the port 123 will switch to a LOW state. The relay 109 is switched based on the operation of the common control lines 102, 104. If common control line 104 is driven HIGH, the opposite occurs and the relay switches to its opposite port. If both the common control lines 102, 104 are both driven LOW, the relay is not supplied with any control voltage; however, if both common control inputs 102, 104 are driven HIGH, the relay is shorted and an error condition would occur. Proper programming techniques should prevent this error condition from occurring.

The present invention works for protection against unplanned state changes of a magnetic latching relay 100 by preventing such relay state changes which might occur due to unwanted vibration or shock applied to the relay. When such an event triggers the unwanted state change, the control voltage from common control lines 102, 104 is no longer impressed on the relay 109. This causes the input on the switching logic 101, 105 to fall to zero volts. This is detected by sense lines connected between ports 121123 and common port 125 through respective isolation resistors 107, 111, 117. The desired control signal, which is still present, will cause the output of the switching logic 101, 105 to swing to a HIGH state for activating the H-bridge 103. Once again, current flows into a relay actuating coil (not shown) in relay 109. This works to set the relay 109 back to the desired state. To summarize, the control voltage from control lines 102, 104 will again be supplied to the desired side of the relay 109 which will then be applied to the switching logic 101, 105. This, in turn, causes its output to swing back to LOW where all current flow is stopped. In this scenario, the relay 109 has now returned to its quiescent state.

Those skilled in the art will recognize that the topology of this invention has an unstable state where both common control lines at ports 102, 104 will be at a HIGH state. In this state, the relay 109 will toggle as fast as its armature can move. In a well-behaved controller situation, this is not a problem, as each control line will only be in one control state, thus avoiding this condition. In situations where it cannot be guaranteed that only one state will be active at a time, an alternative tri-stating embodiment may be used.

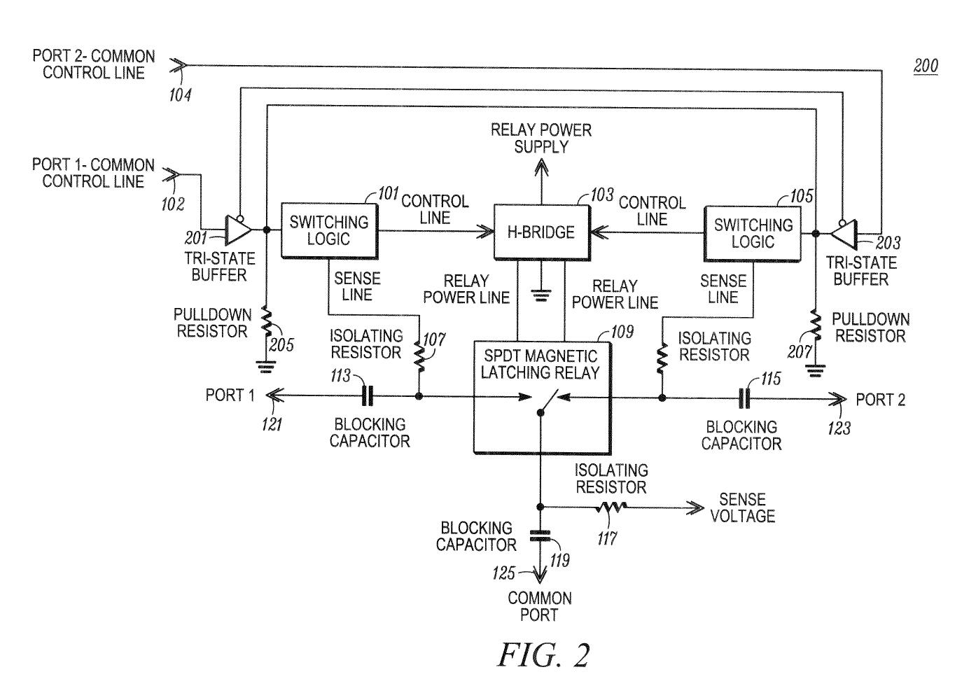

FIG. 2 illustrates an alternative embodiment where only one of the control inputs will be activated by tri-stating the other's input. All of the system components as seen in FIG. 2 are like those in FIG. 1 except for components associated with tri-state control of the relay 109. These components include tri-state buffers 201, 203 which work with control inputs 102, 104. Pulldown resistors 205, 207 are used at the outputs of tri-state buffers 201, 201 to provide a logic LOW to the opposite tri-state buffer's control pin while the output of the buffer is in high impedance output mode. In operation, the dominant control input will be the one that is first to tri-state the other control input's buffer. The control input will remain the dominant control until the controller (not shown) releases the signal to the input, thus allowing the opposite tri-state buffer to return to an active state. The tri-stated active state (typically a 0 volt or a +5 volt logic signal) is applied once the other control signal has returned to a LOW input and released the H-bridge 103.

Thus, the present invention is directed a system which works to protect against unplanned state changes of a magnetic latching relay. The invention utilizes switching logic and an H-bridge circuit to detect an unwanted state change of the relay. The switching logic detects when a control voltage is no longer present which causes the H-bridge to turn “on” restoring the relay back it a desired state.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

I claim:

1. A system for protecting against unplanned state changes of a magnetic latching relay comprising:
at least one switching logic circuit;
a driver circuit controlled by the at least one switching logic circuit for controlling the magnetic latching relay; and
wherein the at least one switching logic circuit detects an unplanned state change of the magnetic latching relay for switching the magnetic latching relay back to a desired state.

2. A system for protecting against an unplanned state change of a magnetic latching relay as in claim 1, wherein the at least one switching logic circuit includes a first switching logic circuit for controlling a first input port and a second switching logic circuit for controlling a second switching logic circuit.

3. A system for protecting against unplanned state changes of a magnetic latching relay as in claim 2, wherein the first switching logic and the second switching logic each utilize a respective common control voltage for actuating the magnetic latching relay.

4. A system for protecting against unplanned state changes of a magnetic latching relay as in claim 1, wherein the magnetic latching relay is a single-pole, double pole relay used in a two-way radio transceiver.

5. A system for protecting against unplanned state changes of a magnetic latching relay as in claim 1, further comprising at least one tri-state buffer for supplying an input to the at least one switching logic circuit.

6. A system for use with a magnetic latching relay for preventing against unplanned state changes comprising:
at least one switching logic circuit for interpreting the state of a control input;
an H-bridge controlled by the at least one switching logic;
a magnetic latching relay powered by the H-bridge; and
wherein the at least one switching logic circuit detects any unplanned state change of the magnetic latching relay for switching the magnetic latching relay back to a desired state.

7. A system for use with a magnetic latching relay as in claim 6, wherein the at least one switching logic circuit includes a first logic switch for controlling a first port of the magnetic latching relay and a second logic switch for controlling a second port of the magnetic latching relay.

8. A system for use with a magnetic latching relay as in claim 6, wherein the H-bridge is comprised of a plurality of metal oxide field effort transistor (MOSFET) gates which switch a relay power supply.

9. A system for use with a magnetic latching relay as in claim 6, wherein the magnetic latching relay is a single-pole double-throw (SPDT) relay.

10. A system for use with a magnetic latching relay as in claim 6, wherein the magnetic switching relay is used in a two-way radio transceiver.

11. A system for use with a magnetic latching relay as in claim 6, further comprising at least one tri-state buffer for supplying an input to the at least one switching logic circuit.

12. A method for protecting from unplanned state changes in a magnetic latching relay comprising the steps of:
utilizing at least one switching logic circuit for interpreting the state of a control input;
controlling an H-bridge using the at least one switching logic;
powering a magnetic latching relay by the H-bridge; and
detecting any unplanned state change of the magnetic latching relay using the at least one switching logic circuit for switching the magnetic latching relay back to a desired state.

13. A method for protecting from unplanned state changes in a magnetic latching relay as in claim 12, further comprising the step of:
including with the at least one switching logic circuit a first logic switch for controlling a first port of the magnetic latching relay and a second logic switch for controlling a second port of the magnetic latching relay.

14. A method for protecting from unplanned state changes in a magnetic latching relay as in claim 12, further comprising the step of including with the H-bridge a plurality of metal oxide field effort transistor (MOSFET) gates which switch a power supply for the magnetic switching relay.

15. A method for protecting from unplanned state changes in a magnetic latching relay as in claim 12, wherein the magnetic latching relay is a single-pole double-throw (SPDT) relay.

16. A method for protecting from unplanned state changes in a magnetic latching relay as in claim 12, further comprising the step of:
utilizing the magnetic switching relay in a two-way radio transceiver.

17. A method for protecting from unplanned state changes in a magnetic latching relay as in claim 12, further comprising the step of:
supplying an input to the at least one switching logic circuit using a tri-state buffer.
